(19) United States
(12) Patent Application Publication
(10) Pub. No.: US 2021/0110180 A1
(43) Pub. Date: Apr. 15, 2021

(54) METHOD AND APPARATUS FOR TRAFFIC SIGN DETECTION, ELECTRONIC DEVICE AND COMPUTER STORAGE MEDIUM

(71) Applicant: BEIJING SENSETIME TECHNOLOGY DEVELOPMENT CO., LTD., Beijing (CN)

(72) Inventors: Hezhang WANG, Beijing (CN); Yuchen MA, Beijing (CN); Tianxiao HU, Beijing (CN); Xingyu ZENG, Beijing (CN); Junjie YAN, Beijing (CN)

(21) Appl. No.: 17/128,629

(22) Filed: Dec. 21, 2020

Related U.S. Application Data
(63) Continuation of application No. PCT/CN2019/098674, filed on Jul. 31, 2019.

(30) Foreign Application Priority Data
Sep. 6, 2018 (CN) 201811036346.1

(51) Int. Cl. G06K 9/00; G06K 9/62; G06K 9/20; G06K 9/46; G06T 7/246; G06T 7/73; G06N 3/04

(52) U.S. Cl. CPC G06K 9/00818; G06T 2207/20084; G06K 9/6256; G06K 9/6277; G06K 9/628; G06K 9/2054; G06K 9/6292; G06K 9/46; G06K 9/6232; G06K 9/00744; G06T 7/248; G06T 7/73; G06N 3/04; G06T 2207/10016; G06T 2207/20081; G06K 9/6227

(57) ABSTRACT

A method and apparatus for multi-level target classification, a method and apparatus for traffic sign detection, an electronic device, and a computer storage medium are provided. The method for multi-level target classification includes: obtaining at least one candidate region feature corresponding to at least one target in an image, where the image includes at least one target, and each of the targets corresponds to one candidate region feature; obtaining at least one first probability vector corresponding to at least two classes based on the at least one candidate region feature, and classifying each of the at least two classes to respectively obtain at least one second probability vector corresponding to at least two sub-classes in the class; and determining a classification probability that the target belongs to the sub-class based on the first probability vector and the second probability vector.

### CROSS-REFERENCE TO RELATED APPLICATIONS

The present disclosure is a U.S. continuation application of International Application No. PCT/CN2019/098674, filed on Jul. 31, 2019, which claims priority to Chinese Patent Application No. 201811036346.1, filed to the Chinese Patent Office on Sep. 6, 2018 and entitled “METHODS AND APPARATUSES FOR MULTI-LEVEL TARGET CLASSIFICATION AND TRAFFIC SIGN DETECTION, DEVICE AND MEDIUM”. The contents of International Application No. PCT/CN2019/098674 and Chinese Patent Application No. 201811036346.1 are incorporated herein by reference in their entireties.

### BACKGROUND

Traffic sign detection is an important issue in the field of automatic driving. Traffic signs play an important role in the modern road system, and transfer signals such as instructions, directions, warnings, and bans to vehicles and pedestrians by using text and graphic symbols to guide vehicles and pedestrians. Correct detection of the traffic signs can plan the speed and direction for an automatic driving vehicle to ensure driving safety of the vehicle. In the real scene, there are various types of road traffic signs, and the road traffic signs are smaller than the general targets such as people and vehicles.

### SUMMARY

The present disclosure relates to computer vision technology, and in particular, to methods and apparatuses for multi-level target classification and traffic sign detection, a device and a medium.

Embodiments of the present disclosure provide a multi-level target classification technique.

According to a first aspect of the embodiments of the present disclosure, provided is a method for multi-level target classification, including:

obtaining at least one candidate region feature corresponding to at least one target in an image, where the image includes at least one target, and each of the at least one target corresponds to one candidate region feature;

obtaining, based on the at least one candidate region feature, at least one first probability vector corresponding to at least two classes, and classifying each of the at least two classes to respectively obtain at least one second probability vector corresponding to at least two sub-classes in the class; and

determining, based on the first probability vector and the second probability vector, a classification probability that the target belongs to the sub-class.

According to another aspect of the embodiments of the present disclosure, provided is a method for traffic sign detection, including:

collecting an image including traffic signs;

obtaining at least one candidate region feature corresponding to at least one traffic sign in the image including traffic signs, each of the at least one traffic sign corresponding to one candidate region feature;

obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class; and

determining, based on the first probability vector and the second probability vector, a classification probability that the traffic sign belongs to the traffic sign sub-class.

According to another aspect of the embodiments of the present disclosure, provided is an apparatus for multi-level target classification, including:

a candidate region obtaining unit, configured to obtain at least one candidate region feature corresponding to at least one target in an image, where the image includes at least one target, and each of the at least one target corresponds to one candidate region feature;

a probability vector unit, configured to obtain, based on the at least one candidate region feature, at least one first probability vector corresponding to at least two classes, and classify each of the at least two classes to respectively obtain at least one second probability vector corresponding to at least two sub-classes in the class; and

a target classification unit, configured to determine, based on the first probability vector and the second probability vector, a classification probability that the target belongs to the sub-class.

According to another aspect of the embodiments of the present disclosure, provided is an apparatus for traffic sign detection, including:

an image collection unit, configured to collect an image including traffic signs;

a traffic sign region unit, configured to obtain at least one candidate region feature corresponding to at least one traffic sign in the image including traffic signs, each of the at least one traffic sign corresponding to one candidate region feature;

a traffic probability vector unit, configured to obtain, based on the at least one candidate region feature, at least one first probability vector corresponding to at least two traffic sign classes, and classify each of the at least two traffic sign classes to respectively obtain at least one second probability vector corresponding to at least two traffic sign sub-classes in the traffic sign class; and

a traffic sign classification unit, configured to determine, based on the first probability vector and the second probability vector, a classification probability that the traffic sign belongs to the traffic sign sub-class.

According to another aspect of the embodiments of the present disclosure, provided is a vehicle, including the apparatus for traffic sign detection according to any one of the embodiments above.

According to another aspect of the embodiments of the present disclosure, provided is an electronic device, including a processor, where the processor includes the apparatus for multi-level target classification according to any one of the embodiments above or the apparatus for traffic sign detection according to any one of the embodiments above.

According to another aspect of the embodiments of the present disclosure, provided is an electronic device, including: a memory, configured to store executable instructions; and

a processor, configured to communicate with the memory to execute the executable instructions to complete operations of the method for multi-level target classification according to any one of the embodiments above or the method for traffic sign detection according to any one of the embodiments above.

According to another aspect of the embodiments of the present disclosure, provided is a non-transitory computer storage medium, configured to store computer readable instructions, where when the instructions are executed, operations of the method for multi-level target classification according to any one of the embodiments above or the method for traffic sign detection according to any one of the embodiments above are executed.

According to another aspect of the embodiments of the present disclosure, provided is a computer program product, including computer readable codes, where when the computer readable codes run in a device, a processor in the device executes instructions for implementing the method for multi-level target classification according to any one of the embodiments above or the method for traffic sign detection according to any one of the embodiments above.

### BRIEF DESCRIPTION OF DRAWINGS

The accompanying drawings constituting a part of the specification describe the embodiments of the present disclosure and are intended to explain the principles of the present disclosure together with the descriptions.

According to the following detailed descriptions, the present disclosure can be understood more clearly with reference to the accompanying drawings.

FIG. 1 is a schematic flowchart of a method for multi-level target classification according to embodiments of the present disclosure.

FIG. 2 is a schematic structural diagram of a classification network in one example of the method for multi-level target classification according to embodiments of the present disclosure.

FIG. 3 is a schematic structural diagram of a feature extraction network in one example of the method for multi-level target classification according to embodiments of the present disclosure.

FIG. 4 is a schematic structural diagram of an apparatus for multi-level target classification according to embodiments of the present disclosure.

FIG. 5 is a schematic flowchart of a method for traffic sign detection according to embodiments of the present disclosure.

FIG. 6a is a schematic diagram showing a traffic sign class in one optional example of the method for traffic sign detection according to embodiments of the present disclosure.

FIG. 6b is a schematic diagram showing another traffic sign class in one optional example of the method for traffic sign detection according to embodiments of the present disclosure.

FIG. 6c is a schematic diagram showing yet another traffic sign class in one optional example of the method for traffic sign detection according to embodiments of the present disclosure.

FIG. 7 is a schematic structural diagram of an apparatus for traffic sign detection according to embodiments of the present disclosure.

FIG. 8 is a schematic structural diagram of an electronic device for implementing a terminal device or a server according to embodiments of the present disclosure.

### DETAILED DESCRIPTION

Various exemplary embodiments of the present disclosure are now described in detail with reference to the accompanying drawings. It should be noted that, unless otherwise stated specifically, relative arrangement of the components and operations, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to a computer system/server, which may operate with numerous other general-purpose or special-purpose computing system environments or configurations. Examples of well-known computing systems, environments, and/or configurations suitable for use together with the computer system/server include, but are not limited to, personal computer systems, server computer systems, thin clients, thick clients, handheld or laptop devices, microprocessor-based systems, set top boxes, programmable consumer electronics, network personal computers, vehicle-mounted devices, small computer systems, large computer systems, distributed cloud computing environments that include any one of the foregoing systems, and the like.

The computer system/server may be described in the general context of computer system executable instructions (for example, program modules) executed by the computer system. Generally, the program modules may include routines, programs, target programs, components, logics, data structures, and the like for performing specific tasks or implementing specific abstract data types. The computer systems/servers may be practiced in the distributed cloud computing environments in which tasks are performed by remote processing devices that are linked through a communications network. In the distributed computing environments, the program modules may be located in local or remote computing system storage media including storage devices.

Based on the method and apparatus for multi-level target classification, the method and apparatus for traffic sign detection, the device, and the medium provided by the embodiments of the present disclosure, the accuracy of target classification in the image is improved by obtaining at least one candidate region feature corresponding to at least one target in an image; obtaining at least one first probability vector corresponding to at least two classes based on the at least one candidate region feature, and classifying each of the at least two classes to respectively obtain at least one second probability vector corresponding to at least two sub-classes in the class; and determining a classification probability that the target belongs to the sub-class based on the first probability vector and the second probability vector. The target size is not limited in the embodiments of the present disclosure, and can be used for classification of large-sized targets, and can also be used for classification of small-sized targets. When the embodiments of the present disclosure are applied to classification of a small-sized target (i.e., a small target) in a photographed picture such as a traffic sign or a traffic light, the accuracy of the small target classification in the image can be effectively improved.

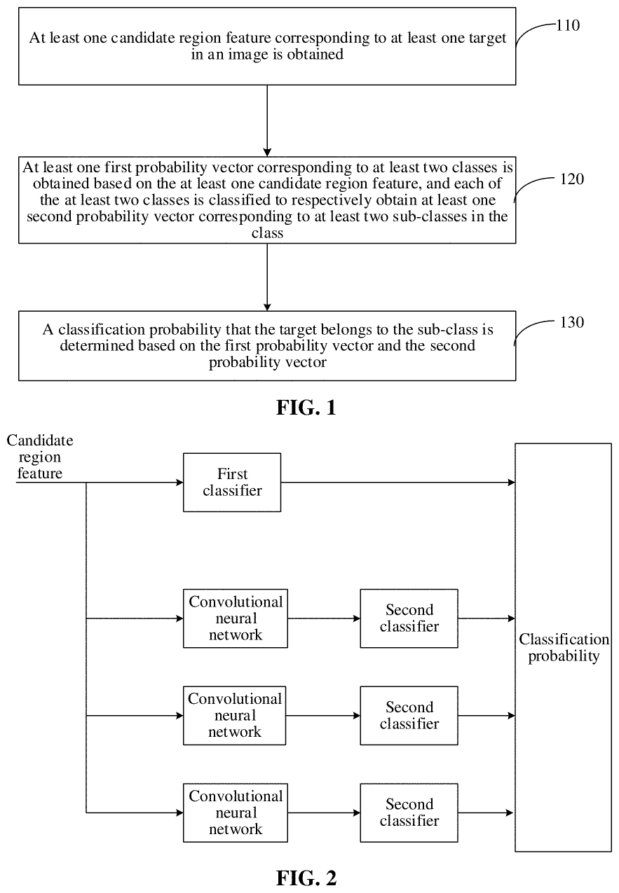

FIG. 1 is a schematic flowchart of a method for multi-level target classification according to embodiments of the present disclosure. As shown in FIG. 1, the method of the embodiments includes the following operations.

At operation 110, at least one candidate region feature corresponding to at least one target in an image is obtained.

The image includes at least one target, and each target corresponds to one candidate region feature. When the image includes multiple targets, in order to perform classification on each of the multiple targets, it is needed to distinguish the targets.

Optionally, a candidate region that possibly includes a target is obtained, at least one candidate region is obtained by clipping, and a candidate region feature is obtained based on the candidate region. Alternatively, feature extraction is performed on the image to obtain an image feature, a candidate region is extracted from the image, and a candidate region feature is obtained by mapping the candidate region to the image feature. The embodiments of the present disclosure are not limited to the specific method for obtaining the candidate region feature.

In one optional example, operation S110 may be performed by a processor by invoking a corresponding instruction stored in a memory, or may be performed by a candidate region obtaining unit 41 run by the processor.

At operation 120, at least one first probability vector corresponding to at least two classes is obtained based on the at least one candidate region feature, and each of the at least two classes is classified to respectively obtain at least one second probability vector corresponding to at least two sub-classes in the class.

Classification is performed based on the candidate region feature respectively to obtain a first probability vector of the corresponding class of the candidate region feature. Moreover, each class may include at least two sub-classes. Classification is performed on the candidate region feature based on the sub-class to obtain a second probability vector of the corresponding sub-class. The target includes, but is not limited to a traffic sign and/or a traffic light. For example, when the target is a traffic sign, the traffic signs include multiple classes (such as warning signs, ban signs, guide signs, and road signs), and each class includes multiple sub-classes (e.g., there are 49 warning signs for warming vehicles and pedestrians to pay attention to dangerous places).

In one optional example, operation S120 may be performed by a processor by invoking a corresponding instruction stored in a memory, or may be performed by a probability vector unit 42 run by the processor.

At operation 130, a classification probability that the target belongs to the sub-class is determined based on the first probability vector and the second probability vector.

In order to confirm the accurate classification of the target, it is not enough to obtain the classification result of the class. Only obtaining the classification result of the class can only determine which class the current target belongs to. Since each class also includes at least two sub-classes, the target needs to be classified in the class to which the target belongs to obtain the sub-class.

In one optional example, operation S130 may be performed by a processor by invoking a corresponding instruction stored in a memory, or may be performed by a target classification unit 43 run by the processor.

Based on the method for multi-level target classification provided by the embodiments of the present disclosure, the accuracy of target classification in the image is improved by obtaining at least one candidate region feature corresponding to at least one target in an image; obtaining at least one first probability vector corresponding to at least two classes based on the at least one candidate region feature, and classifying each of the at least two classes to respectively obtain at least one second probability vector corresponding to at least two sub-classes in the class; and determining a classification probability that the target belongs to the sub-class based on the first probability vector and the second probability vector. The target size is not limited in the embodiments of the present disclosure, and can be used for classification of large-sized targets, and can also be used for classification of small-sized targets. When the embodiments of the present disclosure are applied to classification of a small-sized target (i.e., a small target) in a photographed picture such as a traffic sign or a traffic light, the accuracy of the small target classification in the image can be effectively improved.

In one or more optional embodiments, operation 120 includes:

performing, by a first classifier, classification based on the at least one candidate region feature to obtain at least one first probability vector corresponding to the at least two classes; and

performing classification on each class by means of at least two second classifiers based on the at least one candidate region feature to respectively obtain at least one second probability vector corresponding to at least two sub-classes of the class.

Optionally, the first classifier and the second classifier adopt the existing neural network that can implement classification, where the second classifier implements classification of each classification category in the first classifier, and accurate classification is performed on a number of similar target images by means of the second classifier, for example, road traffic signs, there are more than 200 road traffic signs, and the categories are similar. The existing detection frameworks are unable to simultaneously detect and classify so many categories. The accuracy of classification of multiple road traffic signs can be improved by the embodiments of the present disclosure.

Optionally, each class category corresponds to one second classifier.

The performing, by at least two second classifiers, classification on each of the classes based on the at least one candidate region feature to respectively obtain at least one second probability vector corresponding to at least two sub-classes in the class includes:

determining the class category corresponding to the candidate region feature based on the first probability vector; and

performing classification on the candidate region feature based on the second classifier corresponding to the class, to obtain the second probability vector of the at least two sub-classes corresponding to the candidate region feature.

Optionally, since each second classifier corresponds to one class category, after determining that one candidate region is a certain class category, it can be determined on which second classifier is based to perform fine classification on the second classifier, which reduces the difficulty in target classification. The candidate region may also be input to all second classifiers, and multiple second probability vectors are obtained based on all the second classifiers. Moreover, the classification category of the target is determined by combining the first probability vector and the second probability vector. The classification result of the second probability vector corresponding to the smaller probability value in the first probability vector is reduced, and the classification result of the second probability vector corresponding to the larger probability value (the class category corresponding to the target) in the first probability vector has obvious advantages over the classification results of other second probability vectors. Therefore, the sub-class category of the target can be quickly determined. The classification method provided by the present disclosure improves the detection accuracy in the application of small target detection.

Optionally, before the performing classification on the candidate region feature based on the second classifier corresponding to the class, to obtain the second probability vectors of the at least two sub-classes corresponding to the candidate region feature, the method further includes: processing, by a convolutional neural network, candidate region feature, and inputting the processed candidate region feature into the second classifier corresponding to the class.

FIG. 2 is a schematic structural diagram of a classification network in one example of the method for multi-level target classification according to embodiments of the present disclosure. As shown in FIG. 2, the target of the obtained candidate region is classified into N classes. Since the class category is small and the difference between the classes is large, it is easier to classify, and then, for each sub-class, the convolutional neural network further mines the classification features, and perform fine classification on the sub-classes under each class. In this case, since the second classifier mines different features for different classes, the classification accuracy of the sub-classes can be improved. The convolutional neural network processes the subsequent region features to mine more classification features so that the classification results of the sub-classes are more accurate.

In one or more optional embodiments, operation 130 includes:

determining a first classification probability that the target belongs to the class based on the first probability vector;

determining a second classification probability that the target belongs to the sub-class based on the second probability vector; and

determining a classification probability that the target belongs to the sub-class in the class by combining the first classification probability and the second classification probability.

Optionally, the classification probability that the target belongs to the sub-class in the class is determined based on the product of the first classification probability and the second classification probability. For example, the target is divided into N classes, and assuming that each class contains M sub-classes. The i-th class is labeled as Nᵢ, and the j-th sub-class of the Nᵢ class is labeled as Nᵢⱼ, where M and N are integers greater than 1, and i ranges from 1 to N, and j ranges from 1 to M. The classification probability, i.e., the probability of belonging to a certain sub-class, is obtained by calculation. Formula: P(i,j)=P(Nᵢ)×P(Nᵢⱼ), where P(i,j) represents the classification probability, P(Nᵢ) represents the first classification probability, and P(Nᵢⱼ) represents the second classification probability.

In one or more optional embodiments, before executing operation 120, the method further includes:

training a classification network based on a sample candidate region feature.

The classification network includes one first classifier and at least two second classifiers, and the number of the second classifiers is equal to a class category of the first classifier. The sample candidate region feature has a labeled sub-class category, or has a labeled sub-class category and a labeled class category.

Optionally, the structure of the classification network can be referred to FIG. 2, and the classification network obtained by training can better perform large classification and small classification. Moreover, the sample candidate region features can only label sub-class categories. In this case, in order to implement training of the classification network, optionally, in response to the sample candidate region feature having a labeled sub-class category, the labeled class category corresponding to the sample candidate region feature is determined by clustering the labeled sub-class category. The labeled class category can be obtained by clustering the sample candidate region features. The optional clustering method can aggregate the sample candidate region features having the labeled sub-class categories into several sets by clustering by means of the distance between the sample candidate region features (for example, Euclidean distance, etc.), and each set corresponds to one labeled class category.

By clustering the labeled sub-class categories to obtain corresponding labeled class categories, the class categories to which the sample candidate features belong can be accurately expressed, and moreover, the operations of labeling the class and sub-class respectively are overcome, the manual labeling is reduced, and the labeling accuracy and the training efficiency are improved.

Optionally, the training a classification network based on a sample candidate region feature includes:

inputting the sample candidate region feature into the first classifier to obtain a predicted class category, and adjusting a parameter of the first classifier based on the predicted class category and the labeled class category; and

inputting the sample candidate region feature into the second classifier corresponding to the labeled class category based on the labeled class category of the sample candidate region feature to obtain a predicted sub-class category, and adjusting a parameter of the second classifier based on the predicted sub-class category and the labeled sub-class category.

The first classifier and the at least two second classifiers are respectively trained, so that the obtained classification network realizes the fine classification when the obtained classification network performs coarse classification on the target, and based on the product of the first classification probability and the second classification probability, the classification probability of the accurate small classification of the target can be determined.

In one or more optional embodiments, operation 110 includes:

obtaining the at least one candidate region corresponding to the at least one target based on the image;

performing feature extraction on the image to obtain an image feature corresponding to the image; and

determining the at least one candidate region feature corresponding to the image based on the at least one candidate region and the image feature.

Optionally, the candidate region feature is obtained by means of a Region-based Full Convolutional Neural Network (R-FCN) framework. For example, a candidate region is obtained by means of one branch network, an image feature corresponding to the image is obtained by means of another branch network, and at least one candidate region feature is obtained by using Region of Interest (ROI) pooling based on the candidate region. Optionally, the feature of a corresponding position is obtained from the image feature based on at least one candidate region, to constitute at least one candidate region feature corresponding to the at least one candidate region. Each candidate region corresponds to one candidate region feature.

Optionally, the performing feature extraction on the image to obtain an image feature corresponding to the image includes:

performing, by a convolutional neural network in a feature extraction network, feature extraction on the image to obtain a first feature;

performing, by a residual network in the feature extraction network, differential feature extraction on the image to obtain a differential feature; and

obtaining an image feature corresponding to the image based on the first feature and the differential feature.

Optionally, the first feature extracted by the convolutional neural network is a feature common in the image, and the differential feature extracted by the residual network can represent the difference between the small target object and the large target object. The image features obtained by the first feature and the differential feature reflect the difference between the small target object and the large target object based on the common features in the image, which improves the accuracy of classifying the small target object when classification is performed based on the image feature.

Optionally, bitwise addition is performed on the first feature and the differential feature to obtain the image feature corresponding to the image.

In real-life scenarios, for example, the size of road traffic sign is much smaller than the general target, so the general target detection framework does not consider the detection of small target objects such as traffic signs. The embodiments of the present disclosure improve the feature map resolution of the small target object from various aspects, thereby improving the detection performance.

In the embodiments, the difference between the second target object feature map and the first target object feature map is learned by means of the residual network, thereby improving the expression of the second target object feature. In one optional example, FIG. 3 is a schematic structural diagram of a feature extraction network in one example of the method for multi-level target classification according to embodiments of the present disclosure. As shown in FIG. 3, the general feature is extracted by means of the convolutional neural network, and the differential feature between the second target object and the first target object is learned by means of the residual network, and finally position feature values corresponding to the general feature and the differential feature are added to obtain the image features. Therefore, the detection performance is improved by superimposing the differential features obtained by the residual network.

Optionally, the performing, by a convolutional neural network in a feature extraction network, feature extraction on the image to obtain a first feature includes:

performing, by the convolutional neural network, feature extraction on the image; and

determining the first feature corresponding to the image based on at least two features output by at least two convolutional layers in the convolutional neural network.

In the convolutional neural network, the underlying features often contain more edge information and position information, while the high-level features contain more semantic features. In the embodiments, the underlying features and the high-level features are fused to achieve the use of the underlying features and the high-level features to fuse the underlying features with the high-level features to improve the expression ability of the target feature maps, so that the network can utilize deep semantic information and mine shallow semantic information. Optionally, the fusion method includes, but is not limited to, the method for feature bitwise addition and the like.

Moreover, the method for bitwise addition is implemented only when two feature maps have the same size. Optionally, the process of obtaining the first feature by fusion includes:

processing at least one of the at least two feature maps output by the at least two convolutional layers so that the at least two feature maps have the same size; and

performing bitwise addition on the at least two feature maps having the same size to determine the first feature corresponding to the image.

Optionally, the underlying feature map is usually relatively large, and the high-level feature map is usually relatively small. Therefore, when the high-level feature map and the underlying feature map need to be unified in size, a reduced feature map can be obtained by down-sampling the underlying feature map, or an enlarged feature map can be obtained by interpolating the high-level feature map. Bitwise addition is performed on the adjusted high-level feature map and the underlying feature map to obtain the first feature.

In one or more optional embodiments, before the performing, by a convolutional neural network in a feature extraction network, feature extraction on the image to obtain a first feature, the method further includes:

performing, by a discriminator, adversarial training on the feature extraction network based on a first sample image.

The size of a target object in the first sample image is known, the target object includes a first target object and a second target object, and the size of the first target object is different from that of the second target object. Optionally, the size of the first target object is greater than that of the second target object.

The feature extraction network obtains large target features based on both the first target object and the second target object, and the discriminator is used to discriminate whether the large target feature output by the feature extraction network is obtained based on the real first target object or by combining the second target object with the residual network. In the process of performing adversarial training on the feature extraction network by means of the discriminator, the training target of the discriminator is to accurately distinguish whether the large target feature is obtained based on the real first target object or by combining the second target object with the residual network, and the training target of the feature extraction network is to make the discriminator unable to distinguish whether the large target feature is obtained based on the real first target object or by combining the second target object with the residual network. Therefore, the embodiments of the present disclosure implement the training of the feature extraction network based on the discriminant result obtained by the discriminator.

Optionally, the performing, by a discriminator, adversarial training on the feature extraction network based on a first sample image includes:

inputting the first sample image into the feature extraction network to obtain a first sample image feature;

obtaining, by the discriminator, a discrimination result based on the first sample image feature, the discrimination result being used for representing the authenticity that the first sample image includes the first target object; and

alternately adjusting parameters of the discriminator and the feature extraction network based on the discrimination result and the known size of the target object in the first sample image.

Optionally, the discriminating result may be expressed in the form of a two-dimensional vector, and the two dimensions respectively correspond to the probability that the first sample image feature is a real value and the probability that the first sample image feature is a non-authentic value. Since the size of the target object in the first sample image is known, based on the discrimination result and the known size of the target object, the parameters of the discriminator and the feature extraction network are alternately adjusted to obtain a feature extraction network.

In one or more optional embodiments, the performing feature extraction on the image to obtain an image feature corresponding to the image includes:

performing, by the convolutional neural network, feature extraction on the image; and

determining the image feature corresponding to the image based on at least two features output by at least two convolutional layers in the convolutional neural network.

In the convolutional neural network, the underlying features often contain more edge information and position information, while the high-level features contain more semantic features. In the embodiments of the present disclosure, the underlying features and the high-level features are fused to achieve the use of the underlying features and the high-level features to fuse the underlying features with the high-level features to improve the expression ability of the target feature maps, so that the network can utilize deep semantic information and mine shallow semantic information. Optionally, the fusion method includes, but is not limited to, the method for feature bitwise addition and the like.

Moreover, the method for bitwise addition is implemented only when two feature maps have the same size. Optionally, the process of obtaining the image feature by fusion includes:

processing at least one of the at least two feature maps output by the at least two convolutional layers so that the at least two feature maps have the same size; and

performing bitwise addition on the at least two feature maps having the same size to determine the image feature corresponding to the image.

Optionally, the underlying feature map is usually relatively large, and the high-level feature map is usually relatively small. Therefore, when the high-level feature map and the underlying feature map need to be unified in size, a reduced feature map can be obtained by down-sampling the underlying feature map, or an enlarged feature map can be obtained by interpolating the high-level feature map. Bitwise addition is performed on the adjusted high-level feature map and the underlying feature map to obtain the image feature.

Optionally, before the performing, by the convolutional neural network, feature extraction on the image, the method further includes:

training the convolutional neural network based on a second sample image.

The second sample image includes a labeling image feature.

In order to obtain a better image feature, the convolutional neural network is trained based on the second sample image.

Optionally, the training the convolutional neural network based on a second sample image includes:

inputting the second sample image into the convolutional neural network to obtain a prediction image feature; and

adjusting the parameter of the convolutional neural network based on the prediction image feature and the labeling image feature.

The training process, similar to the common neural network training, can train the convolutional neural network based on a reverse gradient propagation algorithm.

In one or more optional embodiments, operation 110 includes:

obtaining at least one frame of the image from a video, and performing region detection on the image to obtain the at least one candidate region corresponding to the at least one target.

Optionally, the image is obtained based on a video, which may be a vehicle-mounted video or a video captured by other camera device, and region detection is performed on the image obtained based on the video to obtain a candidate region that possibly includes a target.

Optionally, before the obtaining the at least one candidate region corresponding to the at least one target based on the image, the method further includes:

performing keypoint recognition on the at least one frame of the image in the video, and determining a target keypoint corresponding to the target in the at least one frame of the image; and

tracking the target keypoint to obtain a keypoint region of the at least one frame of the image in the video.

After the obtaining the at least one candidate region corresponding to the at least one target based on the image, the method further includes:

adjusting the at least one candidate region according to the keypoint region of the at least one frame of the image, to obtain at least one target candidate region corresponding to the at least one target.

Based on the candidate region obtained by means of the region detection, since the leakage detection of some frames is easily caused due to the small gap between the consecutive images and the selection of the threshold value, the detection effect of the video is improved by means of a static target-based tracking algorithm.

In the embodiments of the present disclosure, the target feature point can be simply understood as a relatively significant point in the image, such as an angular point, and a bright point in a darker region. Recognition is first performed on an ORB feature points in the video image: the definition of the ORB feature point is based on the image gray value around the feature points. During detection, the pixel values around the candidate feature point are considered. If there are enough pixel points in the field around the candidate point and the gray value difference of the candidate feature point reaches a preset value, the candidate point is considered to be a key feature point. For example, the traffic sign is recognized by applying the embodiments. In this case, the keypoint is the traffic sign keypoint, and the traffic sign keypoint can implement the static tracking of the traffic sign in the video.

Optionally, the tracking the target keypoint to obtain a keypoint region of each image in the video includes:

based on a distance between the target keypoints in two consecutive frames of the image in the video;

realizing the tracking of the target keypoint in the video based on the distance between the target keypoints; and

obtaining a keypoint region of the at least one frame of the image in the video.

In order to realize the tracking of the target keypoints, the embodiments of the present disclosure need to determine the same target keypoint in two consecutive frames of the image, that is, the position of the same target keypoint in different frames of the image needs to be determined, so as to realize the tracking of the target keypoints. The embodiments of the present disclosure determine which target keypoints in the two consecutive frames of the image are the same target keypoint by means of the distance between the target keypoints in two consecutive frames of the image, thereby implementing tracking, and the distance between the target keypoints in the two frames of the image includes, but is not limited to, Hamming distance and the like.

The Hamming distance is used in data transmission error control coding Hamming distance is a concept, which means that two (same length) words correspond to different numbers of bits, and the two strings are subjected to XOR, and the statistical result is the number of 1, then this number is the Hamming distance, and the Hamming distance between the two images is the number of data bits that are different between the two images. Based on the Hamming distance between the keypoints of each signal in the two frames of the image, the distance of the signal light moving between the two images can be known, and the tracking of the keypoints of the signal can be realized.

Optionally, the realizing the tracking of the target keypoint in the video based on the distance between the target keypoints includes:

determining the position of a same target keypoint in the two consecutive frames of the image based on a minimum value of the distance between the target keypoints; and

realizing the tracking of the target keypoint in the video according to the position of the same target keypoint in the two consecutive frames of the image.

Optionally, the static feature point tracking is realized by matching feature point (target keypoint) descriptors having smaller image coordinate system distance (e.g., Hamming distance) in the two consecutive frames by using the Bruce Force algorithm, i.e., calculating the distance of the features for each pair of target keypoints, and realizing the ORB feature point matching in two consecutive frames based on the target keypoint having the minimum distance. Moreover, since the picture coordinate system of the target keypoint is located in the candidate region, it is determined that the target keypoint is a static keypoint in the target detection.

The Brute Force algorithm is a common pattern matching algorithm. The idea of the Brute Force algorithm is to match a first character of a target string S with a first character of a pattern string T; if the first characters are equal, continue to compare a second character of S and a second character of T; and if the first characters are not equal, compare the second character of S with the first character of T, and so on in a similar fashion until a final matching result is obtained. The Bruce Force algorithm is a brute-force algorithm. Optionally, the adjusting the at least one candidate region according to the keypoint region of the at least one frame of the image, to obtain at least one target candidate region corresponding to the at least one target includes:

in response to an overlapping ratio of the candidate region to the keypoint region being greater than or equal to a set ratio, using the candidate region as a target candidate region corresponding to the target; and

in response to the overlapping ratio of the candidate region to the keypoint region being less than the set ratio, using the keypoint region as the target candidate region corresponding to the target.

In the embodiments of the present disclosure, the subsequent region is adjusted according to the result of the keypoint tracking. Optionally, if the keypoint region matches with the candidate region, the position of the candidate region does not need to be corrected; if the keypoint region substantially matches with the candidate region, the position of the detection frame (the corresponding candidate region) of the current frame is calculated under the premise that the detection result is unchanged in width and height according to the offset of the static point positions of the consecutive frames; and if the candidate region is not present in the current frame, but appears in the previous frame, the candidate region position is calculated according to the keypoint region and does not exceed the camera range, the candidate region is replaced with the keypoint region.

In application, the method for multi-level target classification provided by the foregoing embodiments of the present disclosure can be used for classifying objects in an image. The number of categories of the objects is large and the categories have tasks of certain similarities, such as traffic signs, animal classification (animals are first classified into different types, such as cats and dogs, and then subdivided into different varieties, such as Huskies and Golden Retriever); obstacle classification (obstacles are first classified into classes, such as pedestrians and vehicles, and then subdivided into different sub-classes, such as bus, truck, and minibus) and the like, the present disclosure does not limit the specific field of application of the method for multi-level target classification.

A person of ordinary skill in the art may understand that all or some operations for implementing the foregoing method embodiments are achieved by a program by instructing related hardware; the foregoing program can be stored in a computer-readable storage medium; when the program is executed, operations including the foregoing method embodiments are executed. Moreover, the foregoing storage medium includes various media capable of storing program codes, such as Read-Only Memory (ROM), Random Access Memory (RAM), a magnetic disk, or an optical disk.

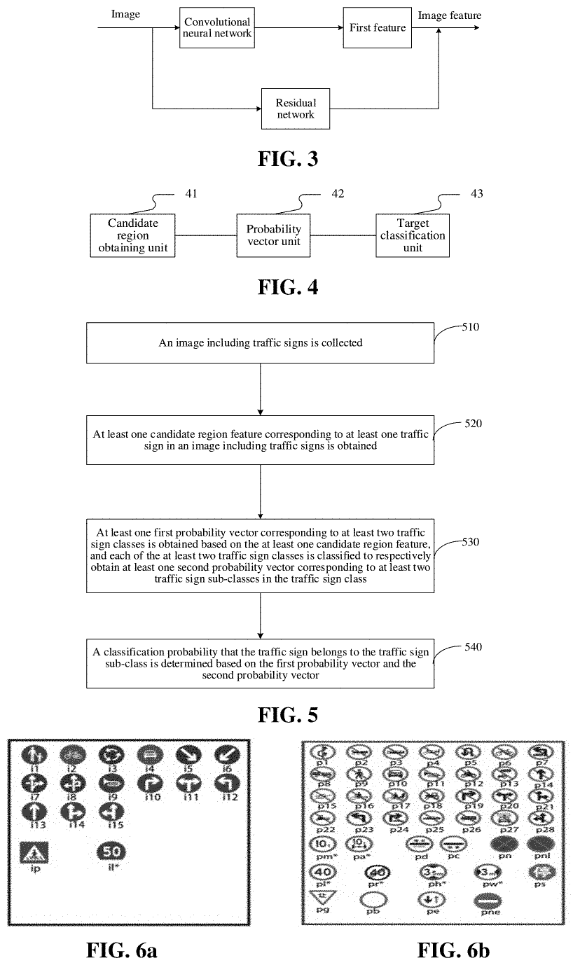

FIG. 4 is a schematic structural diagram of an apparatus for multi-level target classification according to embodiments of the present disclosure. The apparatus of the embodiments is used for implementing the foregoing method embodiments of the present disclosure. As shown in FIG. 4, the apparatus of the embodiments includes:

a candidate region obtaining unit 41, configured to obtain at least one candidate region feature corresponding to at least one target in an image,

where the image includes at least one target, and each target corresponds to one candidate region feature; when the image includes multiple targets, in order to perform classification on each of the multiple targets, it is needed to distinguish the targets;

a probability vector unit 42, configured to obtain at least one first probability vector corresponding to at least two classes based on the at least one candidate region feature, and classify each of the at least two classes to respectively obtain at least one second probability vector corresponding to at least two sub-classes in the class; and

a target classification unit 43, configured to determine a classification probability that the target belongs to the sub-class based on the first probability vector and the second probability vector.

In order to confirm the accurate classification of the target, it is not enough to obtain the classification result of the class. Only obtaining the classification result of the class can only determine which class the current target belongs to. Since each class also includes at least two sub-classes, the target needs to be classified in the class to which the target belongs to obtain the sub-class.

Based on the apparatus for multi-level target classification provided by the foregoing embodiments of the present disclosure, the classification probability that the target belongs to the sub-class is determined based on the first probability vector and the second probability vector, thereby improving the classification accuracy of small targets in the image.

In one or more optional embodiments, the probability vector unit 42 includes:

a first probability module, configured to perform classification by means of a first classifier based on the at least one candidate region feature to obtain at least one first probability vector corresponding to the at least two classes; and

a second probability module, configured to perform classification on each class by means of at least two second classifiers based on the at least one candidate region feature to respectively obtain at least one second probability vector corresponding to at least two sub-classes in the class.

Optionally, each class category corresponds to one second classifier.

The second probability module is configured to determine the class category corresponding to the candidate region feature based on the first probability vector; and perform classification on the candidate region feature based on the second classifier corresponding to the class, to obtain the second probability vector of the at least two sub-classes corresponding to the candidate region feature.

Optionally, the probability vector unit is further configured to process the candidate region feature by means of a convolutional neural network, and input the processed candidate region feature into the second classifier corresponding to the class.

In one or more optional embodiments, the target classification unit 43 is configured to determine a first classification probability that the target belongs to the class based on the first probability vector; determine a second classification probability that the target belongs to the sub-class based on the second probability vector; and determine a classification probability that the target belongs to the sub-class in the class by combining the first classification probability and the second classification probability.

In one or more optional embodiments, the apparatus of the embodiment further includes:

a network training unit, configured to train a classification network based on a sample candidate region feature.

The classification network includes one first classifier and at least two second classifiers, and the number of the second classifiers is equal to a class category of the first classifier. The sample candidate region feature has a labeled sub-class category, or has a labeled sub-class category and a labeled class category.

Optionally, in response to the sample candidate region feature having a labeled sub-class category, the labeled class category corresponding to the sample candidate region feature is determined by clustering the labeled sub-class category.

Optionally, the network training unit is configured to input the sample candidate region feature into the first classifier to obtain a predicted class category; adjust a parameter of the first classifier based on the predicted class category and the labeled class category; input the sample candidate region feature into the second classifier corresponding to the labeled class category based on the labeled class category of the sample candidate region feature to obtain a predicted sub-class category; and adjust a parameter of the second classifier based on the predicted sub-class category and the labeled sub-class category.

In one or more optional embodiments, the candidate region obtaining unit 41 includes:

a candidate region module, configured to obtain the at least one candidate region corresponding to the at least one target based on the image;

a feature extraction module, configured to perform feature extraction on the image to obtain an image feature corresponding to the image; and

a region feature module, configured to determine the at least one candidate region feature corresponding to the image based on the at least one candidate region and the image feature.

Optionally, the candidate region module is configured to obtain a feature of a corresponding position from the image feature based on the at least one candidate region to constitute the at least one candidate region feature corresponding to the at least one candidate region, each of the candidate regions corresponding to one candidate region feature.

Optionally, the feature extraction module is configured to perform feature extraction on the image by means of a convolutional neural network in a feature extraction network to obtain a first feature; perform differential feature extraction on the image by means of a residual network in the feature extraction network to obtain a differential feature; and obtain an image feature corresponding to the image based on the first feature and the differential feature.

Optionally, the feature extraction module is configured to perform bitwise addition on the first feature and the differential feature to obtain the image feature corresponding to the image when the image feature corresponding to the image is obtained based on the first feature and the differential feature.

Optionally, the feature extraction module is configured to perform feature extraction on the image by means of the convolutional neural network; and determine the first feature corresponding to the image based on at least two features output by at least two convolutional layers in the convolutional neural network when feature extraction is performed on the image by means of the convolutional neural network in the feature extraction network to obtain the first feature.

Optionally, the feature extraction module is configured to process at least one of the at least two feature maps output by the at least two convolutional layers so that the at least two feature maps have the same size; and perform bitwise addition on the at least two feature maps having the same size to determine the first feature corresponding to the image when the first feature corresponding to the image is determined based on at least two features output by the at least two convolutional layers in the convolutional neural network.

Optionally, the feature extraction module is further configured to perform adversarial training on the feature extraction network by means of a discriminator based on a first sample image, where the size of a target object in the first sample image is known, the target object includes a first target object and a second target object, and the size of the first target object is different from that of the second target object.

Optionally, the feature extraction module is configured to input the first sample image into the feature extraction network to obtain a first sample image feature; obtain a discrimination result by means of the discriminator based on the first sample image feature, the discrimination result being used for representing the authenticity that the first sample image includes the first target object; and alternately adjust parameters of the discriminator and the feature extraction network based on the discrimination result and the known size of the target object in the first sample image when adversarial training is performed on the feature extraction network by means of the discriminator based on the first sample image.

Optionally, the feature extraction module is configured to perform feature extraction on the image by means of the convolutional neural network; and determine the image feature corresponding to the image based on at least two features output by at least two convolutional layers in the convolutional neural network.

Optionally, the feature extraction module is configured to process at least one of the at least two feature maps output by the at least two convolutional layers so that the at least two feature maps have the same size; and perform bitwise addition on the at least two feature maps having the same size to determine the image feature corresponding to the image when the image feature corresponding to the image is determined based on at least two features output by the at least two convolutional layers in the convolutional neural network.

Optionally, the feature extraction module is further configured to train the convolutional neural network based on a second sample image, the second sample image including a labeling image feature.

Optionally, the feature extraction module is configured to input the second sample image into the convolutional neural network to obtain a prediction image feature; and adjust the parameter of the convolutional neural network based on the prediction image feature and the labeling image feature when the convolutional neural network is trained based on the second sample image.

Optionally, the candidate region module is configured to obtain at least one frame of the image from a video, and perform region detection on the image to obtain the at least one candidate region corresponding to the at least one target.

Optionally, the candidate region obtaining unit further includes:

a keypoint module, configured to perform keypoint recognition on the at least one frame of the image in the video, and determine a target keypoint corresponding to the target in the at least one frame of the image;

a keypoint tracking module, configured to track the target keypoint to obtain a keypoint region of the at least one frame of the image in the video; and

a region adjustment module, configured to adjust the at least one candidate region according to the keypoint region of the at least one frame of the image, to obtain at least one target candidate region corresponding to the at least one target.

Optionally, the keypoint tracking module is configured to based on a distance between the target keypoints in two consecutive frames of the image in the video; realize the tracking of the target keypoint in the video based on the distance between the target keypoints; and obtain a keypoint region of the at least one frame of the image in the video.

Optionally, the keypoint tracking module is configured to determine the position of a same target keypoint in the two consecutive frames of the image based on a minimum value of the distance between the target keypoints; and realize the tracking of the target keypoint in the video according to the position of the same target keypoint in the two consecutive frames of the image when the tracking of the target keypoint in the video is realized based on the distance between the target keypoints.

Optionally, the region adjustment module is configured to use the candidate region as a target candidate region corresponding to the target in response to an overlapping ratio of the candidate region to the keypoint region being greater than or equal to a set ratio; and use the keypoint region as the target candidate region corresponding to the target in response to the overlapping ratio of the candidate region to the keypoint region being less than the set ratio.

The working process, the setting manner, and the corresponding technical effects of any of the embodiments of the apparatus for multi-level target classification provided by the embodiments of the present disclosure may be referred to the specific descriptions of the corresponding method embodiments of the present disclosure, and details are not described again here due to space limitations.

FIG. 5 is a schematic flowchart of a method for traffic sign detection according to embodiments of the present disclosure. As shown in FIG. 5, the method of the embodiments includes the following operations.

At operation 510, an image including traffic signs is collected.

Optionally, the method for traffic sign detection provided by the embodiments of the present disclosure may be applied to intelligent driving, that is, an image including traffic signs is collected by an image collection device disposed on a vehicle, and the classification detection of the traffic signs is implemented based on the detection of the collected image, so as to provide the basis for intelligent driving.

In one optional example, operation S510 may be performed by a processor by invoking a corresponding instruction stored in a memory, or may be performed by an image collection unit 71 run by the processor.

At operation 520, at least one candidate region feature corresponding to at least one traffic sign in an image including traffic signs is obtained.

Each traffic sign corresponds to one candidate region feature. When the image includes multiple traffic signs, in order to separately classify each traffic sign, each traffic sign needs to be separately distinguished.

Optionally, a candidate region that possibly includes a target is obtained, at least one candidate region is obtained by clipping, and a candidate region feature is obtained based on the candidate region. Alternatively, feature extraction is performed on the image to obtain an image feature, a candidate region is extracted from the image, and a candidate region feature is obtained by mapping the candidate region to the image feature. The embodiments of the present disclosure are not limited to the specific method for obtaining the candidate region feature.

In one optional example, operation S520 may be performed by a processor by invoking a corresponding instruction stored in a memory, or may be performed by a traffic sign region unit 72 run by the processor.

At operation 530, at least one first probability vector corresponding to at least two traffic sign classes is obtained based on the at least one candidate region feature, and each of the at least two traffic sign classes is classified to respectively obtain at least one second probability vector corresponding to at least two traffic sign sub-classes in the traffic sign class.

Classification is performed respectively based on the candidate region features, and the first probability vector corresponding to the traffic sign class of the candidate region feature is obtained. Moreover, each traffic sign class includes at least two traffic sign sub-classes, and classification is performed on the candidate region feature based on the traffic sign sub-class to obtain a second probability vector corresponding to the traffic sign sub-class. The traffic sign class includes, but is not limited to, warning signs, ban signs, guide signs, road signs, tourist area signs, and road construction safety signs, and each traffic sign class includes multiple traffic sign sub-classes.

In one optional example, operation S530 may be performed by a processor by invoking a corresponding instruction stored in a memory, or may be performed by a traffic probability vector unit 73 run by the processor.

At operation 540, a classification probability that the traffic sign belongs to the traffic sign sub-class is determined based on the first probability vector and the second probability vector.

In order to confirm the accurate classification of the traffic sign, it is not enough to obtain the classification result of the traffic sign class. Only obtaining the classification result of the traffic sign class can only determine which traffic sign class the current target belongs to. Since each traffic sign class also includes at least two traffic sign sub-classes, the traffic sign needs to be classified in the traffic sign class to which the traffic sign belongs to obtain the traffic sign sub-class.

In one optional example, operation S540 may be performed by a processor by invoking a corresponding instruction stored in a memory, or may be performed by a traffic sign classification unit 74 run by the processor.

Based on the method for traffic sign detection provided by the foregoing embodiments of the present disclosure, the classification accuracy of the traffic signs in the image is improved.

In one or more optional embodiments, operation 530 includes:

performing, by a first classifier, classification based on the at least one candidate region feature to obtain at least one first probability vector corresponding to the at least two traffic sign classes; and

performing, by at least two second classifiers, classification on each traffic sign class based on the at least one candidate region feature to respectively obtain at least one second probability vector corresponding to at least two traffic sign sub-classes in the traffic sign class.

Optionally, due to the variety of traffic signs and the similarity between categories, the existing detection framework cannot detect and classify so many types at the same time. In the embodiments, the traffic signs are classified by means of a multi-level classifier, and a good classification result is achieved. The first classifier and the second classifier may adopt an existing neural network that can implement classification, where the second classifier implements the classification of each traffic sign class in the first classifier. The classification accuracy of a large number of similar traffic signs is improved by using the second classifier.

Optionally, each traffic sign class category corresponds to one second classifier.

The performing, by at least two second classifiers, classification on each traffic sign class based on the at least one candidate region feature to respectively obtain at least one second probability vector corresponding to at least two traffic sign sub-classes in the traffic sign class includes:

determining the traffic sign class category corresponding to the candidate region feature based on the first probability vector; and

performing classification on the candidate region feature based on the second classifier corresponding to the traffic sign class, to obtain the second probability vector of the at least two traffic sign sub-classes corresponding to the candidate region feature.

In the embodiments, since each traffic sign class category corresponds to one second classifier, after determining that one candidate region is a certain traffic sign class category, it can be determined on which second classifier is based to perform fine classification on the second classifier, which reduces the difficulty in traffic sign classification. The candidate region may also be input to all second classifiers, and multiple second probability vectors are obtained based on all the second classifiers. Moreover, the classification category of the traffic sign is determined by combining the first probability vector and the second probability vector. The classification result of the second probability vector corresponding to the smaller probability value in the first probability vector is reduced, and the classification result of the second probability vector corresponding to the larger probability value (the traffic sign class category corresponding to the traffic sign) in the first probability vector has obvious advantages over the classification results of other second probability vectors. Therefore, the traffic sign sub-class category of the traffic sign can be quickly determined.

Optionally, before the performing classification on the candidate region feature based on the second classifier corresponding to the traffic sign class, to obtain the second probability vector of the at least two traffic sign sub-classes corresponding to the candidate region feature, the method further includes:

processing, by a convolutional neural network, the candidate region feature, and inputting the processed candidate region feature into the second classifier corresponding to the traffic sign class.

When the traffic sign class includes N classes, the traffic signs of the candidate region obtained are classified in the N classes. Since the traffic sign class categories are less and the difference between the categories is large, it is easier to classify, and then for each traffic sign sub-class, the convolutional neural network is used to further mine the classification features, and fine classification is performed on the traffic sign sub-classes under each traffic sign class. In this case, the second classifier mines different features for different traffic sign classes, so it can improve the classification accuracy of traffic sign sub-classes. The convolutional neural network is used to process the subsequent regional features, and more classification features can be mined, so that the classification result of traffic sign classes is more accurate.

In one or more optional embodiments, operation 540 includes:

determining a first classification probability that the target belongs to the traffic sign class based on the first probability vector;

determining a second classification probability that the target belongs to the traffic sign class based on the second probability vector; and

determining a classification probability that the traffic sign belongs to the traffic sign sub-class in the traffic sign class by combining the first classification probability and the second classification probability.

Optionally, the classification probability that the traffic sign belongs to the traffic sign sub-class in the traffic sign class is determined based on the product of the first classification probability and the second classification probability.

In one or more optional embodiments, before executing operation 530, the method further includes:

training a traffic classification network based on a sample candidate region feature.

Optionally, the traffic classification network may be a deep neural network of any structure for implementing a classification function, such as a convolutional neural network for implementing the classification function. For example, the traffic classification network includes one first classifier and at least two second classifiers. The number of the second classifiers is equal to the traffic class category of the first classifier. The sample candidate region feature has a labeled traffic sign sub-class category or has a labeled traffic sign sub-class category and a labeled traffic sign class category.

Optionally, the structure of the traffic classification network can be referred to FIG. 2, and the traffic classification network obtained by training can better perform large classification and small classification. Moreover, the sample candidate region features can only label traffic sign sub-class categories. In this case, in order to implement training of the traffic classification network, optionally, in response to the sample candidate region feature having a labeled traffic sign sub-class category, the labeled traffic sign class category corresponding to the sample candidate region feature is determined by clustering the labeled traffic sign sub-class category. The labeled traffic sign class category is obtained by clustering the sample candidate region features. The optional clustering method can refer to the embodiments in the method for multi-level target classification, and details are not described again in the embodiments. The embodiments reduce the manual labeling operation and improve the labeling accuracy and the training efficiency.

Optionally, the training a traffic classification network based on a sample candidate region feature includes:

inputting the sample candidate region feature into the first classifier to obtain a predicted traffic sign class category, and adjusting a parameter of the first classifier based on the predicted traffic sign class category and the labeled traffic sign class category; and

inputting the sample candidate region feature into the second classifier corresponding to the labeled traffic sign class category based on the labeled traffic sign class category of the sample candidate region feature to obtain a predicted traffic sign sub-class category, and adjusting a parameter of the second classifier based on the predicted traffic sign sub-class category and the labeled traffic sign sub-class category.

The first classifier and the at least two second classifiers are respectively trained, so that the obtained traffic classification network realizes the fine classification when the obtained traffic classification network performs coarse classification on the traffic sign, and based on the product of the first classification probability and the second classification probability, the classification probability of the accurate small classification of the traffic sign can be determined.

In one or more optional embodiments, operation 520 includes:

obtaining the at least one candidate region corresponding to the at least one traffic sign based on the image including traffic signs;

performing feature extraction on the image to obtain an image feature corresponding to the image; and

determining the at least one candidate region feature corresponding to the image including traffic signs based on the at least one candidate region and the image feature.

Optionally, the candidate region feature is obtained by means of the R-FCN network framework.

Optionally, the performing feature extraction on the image to obtain an image feature corresponding to the image includes:

performing, by a convolutional neural network in a feature extraction network, feature extraction on the image to obtain a first feature;

performing, by a residual network in the feature extraction network, differential feature extraction on the image to obtain a differential feature; and

obtaining an image feature corresponding to the image based on the first feature and the differential feature.

Optionally, the image feature obtained by means of the first feature and the differential feature reflects a difference between the small target object and the large target object based on the common feature in the image, which improves the accuracy of classification of small target objects (traffic signs in the embodiments) when classification is performed based on the image feature.

Optionally, the obtaining an image feature corresponding to the image based on the first feature and the differential feature includes:

performing bitwise addition on the first feature and the differential feature to obtain the image feature corresponding to the image.

Optionally, the performing, by a convolutional neural network in a feature extraction network, feature extraction on the image to obtain a first feature includes:

performing, by the convolutional neural network, feature extraction on the image; and

determining the first feature corresponding to the image based on at least two features output by at least two convolutional layers in the convolutional neural network.

For the implementation process and the beneficial effects of the embodiments, reference can be made to the embodiments in the foregoing method for multi-level target classification, and details are not described again in the embodiments.

Moreover, the method for bitwise addition is implemented only when two feature maps have the same size. Optionally, the process of obtaining the first feature by fusion includes:

processing at least one of the at least two feature maps output by the at least two convolutional layers so that the at least two feature maps have the same size; and

performing bitwise addition on the at least two feature maps having the same size to determine the first feature corresponding to the image.

Optionally, the underlying feature map is usually relatively large, and the high-level feature map is usually relatively small. In the embodiments, the underlying feature map or the high-level feature map may be resized, and the adjusted high-level feature map and the underlying feature map are subjected to bitwise addition to obtain the first feature.

In one or more optional embodiments, before the performing, by a convolutional neural network in a feature extraction network, feature extraction on the image to obtain a first feature, the method further includes:

performing, by a discriminator, adversarial training on the feature extraction network based on a first sample image.

The size of a traffic sign in the first sample image is known, the traffic sign includes a first traffic sign and a second traffic sign, and the size of the first traffic sign is different from that of the second traffic sign. Optionally, the size of the first traffic sign is greater than that of the second traffic sign.

For the adversarial training process and the beneficial effects of the embodiments, reference can be made to the embodiments in the method for multi-level target classification, and details are not described again in the embodiments.

Optionally, the performing, by a discriminator, adversarial training on the feature extraction network based on a first sample image includes:

inputting the first sample image into the feature extraction network to obtain a first sample image feature;

obtaining, by the discriminator, a discrimination result based on the first sample image feature, the discrimination result being used for representing the authenticity that the first sample image includes the first traffic sign; and

alternately adjusting parameters of the discriminator and the feature extraction network based on the discrimination result and the known size of the traffic sign in the first sample image.

Optionally, the discriminating result may be expressed in the form of a two-dimensional vector, and the two dimensions respectively correspond to the probability that the first sample image feature is a real value and the probability that the first sample image feature is a non-authentic value. Since the size of the traffic sign in the first sample image is known, based on the discrimination result and the known size of the traffic sign, the parameters of the discriminator and the feature extraction network are alternately adjusted to obtain a feature extraction network.

In one or more optional embodiments, the performing feature extraction on the image to obtain an image feature corresponding to the image includes:

performing, by the convolutional neural network, feature extraction on the image; and

determining the image feature corresponding to the image based on at least two features output by at least two convolutional layers in the convolutional neural network.

The embodiments of the present disclosure adopt a method of fusing the underlying features and the high-level features to realize the use of the underlying features and the high-level features to fuse the underlying features and the high-level features, thereby improving the expression capability of the detection target feature map, so that the network can use deep semantic information, and can also fully mine shallow semantic information. Optionally, the fusion method includes, but is not limited to, feature bitwise addition and the like.

Optionally, the determining the image feature corresponding to the image based on at least two features output by at least two convolutional layers in the convolutional neural network includes:

processing at least one of the at least two feature maps output by the at least two convolutional layers so that the at least two feature maps have the same size; and

performing bitwise addition on the at least two feature maps having the same size to determine the image feature corresponding to the image.

Optionally, in the embodiments, the adjusted high-level feature map and the underlying feature map are subjected to bitwise addition by resizing the underlying feature map or the high-level feature map to obtain the image feature.

Optionally, before the performing, by the convolutional neural network, feature extraction on the image, the method further includes:

training the convolutional neural network based on a second sample image.

The second sample image includes a labeling image feature.

In order to obtain a better image feature, the convolutional neural network is trained based on the second sample image.

Optionally, the training the convolutional neural network based on a second sample image includes:

inputting the second sample image into the convolutional neural network to obtain a prediction image feature; and

adjusting the parameter of the convolutional neural network based on the prediction image feature and the labeling image feature.

The training process, similar to the common neural network training, can train the convolutional neural network based on a reverse gradient propagation algorithm.

In one or more optional embodiments, operation 520 includes:

obtaining at least one frame of the image including traffic signs from a video, and performing region detection on the image to obtain the at least one candidate region corresponding to the at least one traffic sign.

Optionally, the image is obtained based on a video, which may be a vehicle-mounted video or a video captured by other camera device mounted on the vehicle, and region detection is performed on the image obtained based on the video to obtain a candidate region that possibly includes a traffic sign.

Optionally, before the obtaining the at least one candidate region corresponding to the at least one traffic sign based on the image including traffic signs, the method further includes:

performing keypoint recognition on the at least one frame of the image in the video, and determining a traffic sign keypoint corresponding to the traffic sign in the at least one frame of the image; and

tracking the traffic sign keypoint to obtain a keypoint region of the at least one frame of the image in the video.

After the obtaining the at least one candidate region corresponding to the at least one traffic sign based on the image, the method further includes:

adjusting the at least one candidate region according to the keypoint region of the at least one frame of the image, to obtain at least one traffic sign candidate region corresponding to the at least one traffic sign.

Based on the candidate region obtained by means of the region detection, since the leakage detection of some frames is easily caused due to the small gap between the consecutive images and the selection of the threshold value, the detection effect of the video is improved by means of a static target-based tracking algorithm.

In the embodiments of the present disclosure, the target feature point can be simply understood as a relatively significant point in the image, such as an angular point, and a bright point in a darker region.

Optionally, the tracking the traffic sign keypoint to obtain a keypoint region of each image in the video includes:

based on a distance between the traffic sign keypoints in two consecutive frames of the image in the video;

realizing the tracking of the traffic sign keypoint in the video based on the distance between the traffic sign keypoints; and

obtaining a keypoint region of the at least one frame of the image in the video.

In the embodiments of the present disclosure, in order to realize the tracking of the target keypoint, it is necessary to determine the same target keypoint in two consecutive frames of the image. Optionally, for the tracking of the traffic sign keypoint, reference can be made to the corresponding embodiments in the foregoing method for multi-level target classification, and details are not described again in the embodiments.

Optionally, the realizing the tracking of the traffic sign keypoint in the video based on the distance between the traffic sign keypoints includes:

determining the position of a same traffic sign keypoint in the two consecutive frames of the image based on a minimum value of the distance between the traffic sign keypoints; and

realizing the tracking of the traffic sign keypoint in the video according to the position of the same traffic sign keypoint in the two consecutive frames of the image.

Optionally, for the tracking process of the traffic sign keypoint provided in the embodiments, reference can be made to the corresponding embodiments in the foregoing method for multi-level target classification, and details are not described again in the embodiments. Optionally, the adjusting the at least one candidate region according to the keypoint region of the at least one frame of the image, to obtain at least one traffic sign candidate region corresponding to the at least one traffic sign includes:

in response to an overlapping ratio of the candidate region to the keypoint region being greater than or equal to a set ratio, using the candidate region as a traffic sign candidate region corresponding to the traffic sign; and

in response to the overlapping ratio of the candidate region to the keypoint region being less than the set ratio, using the keypoint region as the traffic sign candidate region corresponding to the traffic sign.

In the embodiments of the present disclosure, the subsequent region is adjusted according to the result of the keypoint tracking. Optionally, for the adjustment of the traffic sign candidate region provided by the embodiments, reference can be made to the corresponding embodiments in the foregoing method for multi-level target classification, and details are not described again in the embodiments.

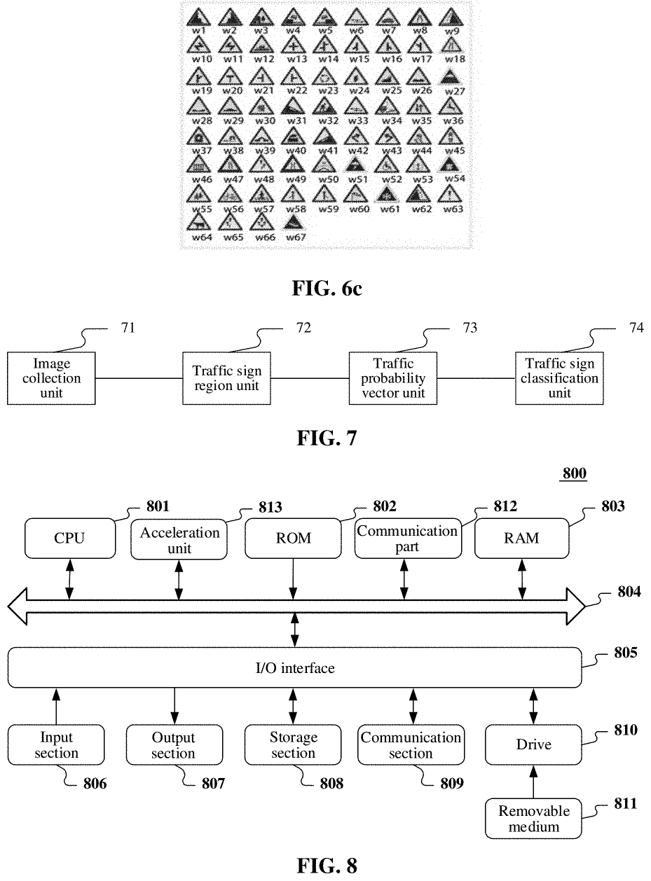

FIG. 6a is a schematic diagram showing a traffic sign class in one optional example of the method for traffic sign detection according to embodiments of the present disclosure. As shown in FIG. 6a, there are multiple traffic signs in the drawing. Each traffic sign belongs to a different traffic sign sub-class, and all traffic signs belong to the indication signs (one of the traffic sign class). For example, the traffic sign labeled by HO indicates turn right, the traffic sign labeled by i12 indicates turn left, and the traffic sign labeled by i13 indicates go straight. The traffic sign classes includes, but are not limited to, warning signs, ban signs, indication signs, guide signs, tourist area signs and road construction safety signs. FIG. 6b is a schematic diagram showing another traffic sign class in one optional example of the method for traffic sign detection according to embodiments of the present disclosure. As shown in FIG. 6b, there are multiple traffic signs in the drawing. Each traffic sign belongs to a different traffic sign sub-class, and all traffic signs belong to ban signs (one of the traffic sign class). For example, the traffic sign labeled by p9 indicates pedestrian prohibited, and the traffic sign labeled by p19 indicates no right turn. FIG. 6c is a schematic diagram showing yet another traffic sign class in one optional example of the method for traffic sign detection according to embodiments of the present disclosure. As shown in FIG. 6c, there are multiple traffic signs in the drawing. Each traffic sign belongs to a different traffic sign sub-class, and all traffic signs belong to warning signs (one of the traffic sign class). For example, the traffic sign labeled by w20 indicates T-shaped intersection, and the traffic sign labeled by w47 indicates that the road ahead narrows to the right.

A person of ordinary skill in the art may understand that all or some operations for implementing the foregoing method embodiments are achieved by a program by instructing related hardware; the foregoing program can be stored in a computer-readable storage medium; when the program is executed, operations including the foregoing method embodiments are executed. Moreover, the foregoing storage medium includes various media capable of storing program codes, such as ROM, RAM, a magnetic disk, or an optical disk.

FIG. 7 is a schematic structural diagram of an apparatus for traffic sign detection according to embodiments of the present disclosure. The apparatus of the embodiments is used for implementing the foregoing embodiments of the method for traffic sign detection of the present disclosure. As shown in FIG. 7, the apparatus of the embodiments includes:

an image collection unit 71, configured to collect an image including traffic signs;

a traffic sign region unit 72, configured to obtain at least one candidate region feature corresponding to at least one traffic sign in the image including traffic signs, each traffic sign corresponding to one candidate region feature;

a traffic probability vector unit 73, configured to obtain at least one first probability vector corresponding to at least two traffic sign classes based on the at least one candidate region feature, and classify each of the at least two traffic sign classes to respectively obtain at least one second probability vector corresponding to at least two traffic sign sub-classes in the traffic sign class; and

a traffic sign classification unit 74, configured to determine a classification probability that the traffic sign belongs to the traffic sign sub-class based on the first probability vector and the second probability vector.

Based on the apparatus for traffic sign detection provided by the foregoing embodiments of the present disclosure, the classification accuracy of the traffic signs in the image is improved.

In one or more optional embodiments, the traffic probability vector unit 73 includes:

a first probability module, configured to perform classification by means of a first classifier based on the at least one candidate region feature to obtain at least one first probability vector corresponding to the at least two traffic sign classes; and

a second probability module, configured to perform classification on each traffic sign class by means of at least two second classifiers based on the at least one candidate region feature to respectively obtain at least one second probability vector corresponding to at least two traffic sign sub-classes in the traffic sign class.

Optionally, each traffic sign class category corresponds to one second classifier.

The second probability module is configured to determine the traffic sign class category corresponding to the candidate region feature based on the first probability vector; and perform classification on the candidate region feature based on the second classifier corresponding to the traffic sign class, to obtain the second probability vector of the at least two traffic sign sub-classes corresponding to the candidate region feature.

Optionally, the traffic probability vector unit 73 is further configured to process the candidate region feature by means of a convolutional neural network, and input the processed candidate region feature into the second classifier corresponding to the traffic sign class.

In one or more optional embodiments, the traffic sign classification unit 74 is configured to determine a first classification probability that the traffic sign belongs to the traffic sign class based on the first probability vector; determine a second classification probability that the target belongs to the traffic sign sub-class based on the second probability vector; and determine a classification probability that the traffic sign belongs to the traffic sign sub-class in the traffic sign class by combining the first classification probability and the second classification probability.

In one or more optional embodiments, the apparatus of the embodiment further includes:

a traffic network training unit, configured to train a traffic classification network based on a sample candidate region feature.

The traffic classification network includes one first classifier and at least two second classifiers, and the number of the second classifiers is equal to a traffic sign class category of the first classifier. The sample candidate region feature has a labeled traffic sign sub-class category, or has a labeled traffic sign sub-class category and a labeled traffic sign class category.

Optionally, in response to the sample candidate region feature having a labeled traffic sign sub-class category, the labeled traffic sign class category corresponding to the sample candidate region feature is determined by clustering the labeled traffic sign sub-class category.

Optionally, the traffic network training unit is configured to input the sample candidate region feature into the first classifier to obtain a predicted traffic sign class category; adjust a parameter of the first classifier based on the predicted traffic sign class category and the labeled traffic sign class category; input the sample candidate region feature into the second classifier corresponding to the labeled traffic sign class category based on the labeled traffic sign class category of the sample candidate region feature to obtain a predicted traffic sign sub-class category; and adjust a parameter of the second classifier based on the predicted traffic sign sub-class category and the labeled traffic sign sub-class category.

In one or more optional embodiments, the traffic sign region unit 72 includes:

a sign candidate region module, configured to obtain the at least one candidate region corresponding to the at least one traffic sign based on the image including traffic signs;

an image feature extraction module, configured to perform feature extraction on the image to obtain an image feature corresponding to the image; and

a labeling region feature module, configured to determine the at least one candidate region feature corresponding to the image including traffic signs based on the at least one candidate region and the image feature.

Optionally, the sign candidate region module is configured to obtain a feature of a corresponding position from the image feature based on the at least one candidate region to constitute the at least one candidate region feature corresponding to the at least one candidate region, each candidate region corresponding to one candidate region feature.

Optionally, the image feature extraction module is configured to perform feature extraction on the image by means of a convolutional neural network in a feature extraction network to obtain a first feature; perform differential feature extraction on the image by means of a residual network in the feature extraction network to obtain a differential feature; and obtain an image feature corresponding to the image based on the first feature and the differential feature.

Optionally, the image feature extraction module is configured to perform bitwise addition on the first feature and the differential feature to obtain the image feature corresponding to the image when the image feature corresponding to the image is obtained based on the first feature and the differential feature.

Optionally, the image feature extraction module is configured to perform feature extraction on the image by means of the convolutional neural network; and determine the first feature corresponding to the image based on at least two features output by at least two convolutional layers in the convolutional neural network when feature extraction is performed on the image by means of the convolutional neural network in the feature extraction network to obtain the first feature.

Optionally, the image feature extraction module is configured to process at least one of the at least two feature maps output by the at least two convolutional layers so that the at least two feature maps have the same size; and perform bitwise addition on the at least two feature maps having the same size to determine the first feature corresponding to the image when the first feature corresponding to the image is determined based on at least two features output by the at least two convolutional layers in the convolutional neural network.

Optionally, the image feature extraction module is further configured to perform adversarial training on the feature extraction network by means of a discriminator based on a first sample image, where the size of a traffic sign in the first sample image is known, the traffic sign includes a first traffic sign and a second traffic sign, and the size of the first traffic sign is different from that of the second traffic sign.

Optionally, the image feature extraction module is configured to input the first sample image into the feature extraction network to obtain a first sample image feature; obtain a discrimination result by means of the discriminator based on the first sample image feature, the discrimination result being used for representing the authenticity that the first sample image includes the first traffic sign; and alternately adjust parameters of the discriminator and the feature extraction network based on the discrimination result and the known size of the traffic sign in the first sample image when adversarial training is performed on the feature extraction network by means of the discriminator based on the first sample image.

In one or more optional embodiments, the image feature extraction module is configured to perform feature extraction on the image by means of the convolutional neural network; and determine the image feature corresponding to the image based on at least two features output by at least two convolutional layers in the convolutional neural network.

Optionally, the image feature extraction module is configured to process at least one of the at least two feature maps output by the at least two convolutional layers so that the at least two feature maps have the same size; and perform bitwise addition on the at least two feature maps having the same size to determine the image feature corresponding to the image when the image feature corresponding to the image is determined based on at least two features output by the at least two convolutional layers in the convolutional neural network.

Optionally, the image feature extraction module is further configured to train the convolutional neural network based on a second sample image, the second sample image including a labeling image feature.

Optionally, the image feature extraction module is configured to input the second sample image into the convolutional neural network to obtain a prediction image feature; and adjust the parameter of the convolutional neural network based on the prediction image feature and the labeling image feature when the convolutional neural network is trained based on the second sample image.

Optionally, the sign candidate region module is configured to obtain at least one frame of the image including traffic signs from a video, and perform region detection on the image to obtain the at least one candidate region corresponding to the at least one traffic sign.

Optionally, the traffic sign region unit further includes:

a sign keypoint module, configured to perform keypoint recognition on the at least one frame of the image in the video, and determine a traffic sign keypoint corresponding to the traffic sign in the at least one frame of the image;

a sign keypoint tracking module, configured to track the traffic sign keypoint to obtain a keypoint region of the at least one frame of the image in the video; and

a sign region adjustment module, configured to adjust the at least one candidate region according to the keypoint region of the at least one frame of the image, to obtain at least one traffic sign candidate region corresponding to the at least one traffic sign.

Optionally, the sign keypoint tracking module is configured to based on a distance between the traffic sign keypoints in two consecutive frames of the image in the video; realize the tracking of the traffic sign keypoint in the video based on the distance between the traffic sign keypoints; and obtain a keypoint region of the at least one frame of the image in the video.

Optionally, the sign keypoint tracking module is configured to determine the position of a same traffic sign keypoint in the two consecutive frames of the image based on a minimum value of the distance between the traffic sign keypoints; and realize the tracking of the traffic sign keypoint in the video according to the position of the same traffic sign keypoint in the two consecutive frames of the image when the tracking of the traffic sign keypoint in the video is realized based on the distance between the traffic sign keypoints.

Optionally, the sign region adjustment module is configured to use the candidate region as a traffic sign candidate region corresponding to the traffic sign in response to an overlapping ratio of the candidate region to the keypoint region being greater than or equal to a set ratio; and use the keypoint region as the traffic sign candidate region corresponding to the traffic sign in response to the overlapping ratio of the candidate region to the keypoint region being less than the set ratio.

The working process, the setting manner, and the corresponding technical effects of any of the embodiments of the apparatus for traffic sign detection provided by the embodiments of the present disclosure may be referred to the specific descriptions of the corresponding method embodiments of the present disclosure, and details are not described again here due to space limitations.

According to another aspect of the embodiments of the present disclosure, provided is a vehicle, including the apparatus for traffic sign detection according to any one of the embodiments above.

According to another aspect of the embodiments of the present disclosure, provided is an electronic device, including a processor, where the processor includes the apparatus for multi-level target classification according to any one of the embodiments above or the apparatus for traffic sign detection according to any one of the embodiments above.

According to another aspect of the embodiments of the present disclosure, provided is an electronic device, including: a memory, configured to store an executable instruction; and a processor, configured to communicate with the memory to execute the executable instruction to complete operations of the method for multi-level target classification according to any one of the embodiments above or the method for traffic sign detection according to any one of the embodiments above.

According to another aspect of the embodiments of the present disclosure, provided is a computer storage medium, configured to store a computer readable instruction, where when the instruction is executed, operations of the method for multi-level target classification according to any one of the embodiments above or the method for traffic sign detection according to any one of the embodiments above are executed.

The embodiments of the present disclosure also provide an electronic device which, for example, may be a mobile terminal, a Personal Computer (PC), a tablet computer, a server, and the like. Referring to FIG. 8 below, illustrated is a schematic structural diagram of an electronic device 800, which may be a terminal device or a server, suitable for implementing the embodiments of the present disclosure. As shown in FIG. 8, the electronic device 800 includes one or more processors, a communication part, and the like. The one or more processors are, for example, one or more Central Processing Units (CPUs) 801 and/or one or more dedicated processors. The dedicated processor is used as an acceleration unit 813, including, but not limited to, dedicated processors such as a Graphic Processing Unit (GPU), an FPGA, a DSP, and other ASIC chips. The processor may execute appropriate actions and processing according to executable instructions stored in an ROM 802 or executable instructions loaded from a storage section 808 to an RAM 803. The communication part 812 may include, but is not limited to, a network card. The network card may include, but is not limited to, an Infiniband (IB) network card.

The processor is communicated with the ROM 802 and/or the RAM 803 to execute executable instructions, is connected to the communication part 812 by means of a bus 804, and is communicated with other target devices by means of the communication part 812, thereby completing operations corresponding to the methods provided by the embodiments of the present disclosure, e.g., obtaining at least one candidate region feature corresponding to at least one target in an image; obtaining at least one first probability vector corresponding to at least two classes based on the at least one candidate region feature, and classifying each class to respectively obtain at least one second probability vector corresponding to at least two sub-classes in the class; and determining a classification probability that the target belongs to the sub-class based on the first probability vector and the second probability vector.

In addition, the RAM 803 may further store various programs and data required for operations of an apparatus. The CPU 801, the ROM 802, and the RAM 803 are connected to each other via the bus 804. In the case that the RAM 803 exists, the ROM 802 is an optional module. The RAM 803 stores executable instructions, or writes the executable instructions to the ROM 802 during running. The executable instructions cause the CPU 801 to execute corresponding operations of the foregoing communication method. An Input/Output (I/O) interface 805 is also connected to the bus 804. The communication part 812 is integrated, or is configured to have multiple sub-modules (for example, multiple IB network cards) connected to the bus.

The following components are connected to the I/O interface 805: an input section 806 including a keyboard, a mouse and the like; an output section 807 including a Cathode-Ray Tube (CRT), a Liquid Crystal Display (LCD), a speaker and the like; the storage section 808 including a hard disk drive and the like; and a communication section 809 of a network interface card including an LAN card, a modem and the like. The communication section 809 performs communication processing via a network such as the Internet. A drive 810 is also connected to the I/O interface 805 according to requirements. A removable medium 811 such as a magnetic disk, an optical disk, a magneto-optical disk, a semiconductor memory or the like is mounted on the drive 810 according to requirements, so that a computer program read from the removable medium is installed on the storage section 808 according to requirements.

It should be noted that the architecture shown in FIG. 8 is merely an optional implementation. During specific practice, the number and types of the components in FIG. 8 are selected, decreased, increased, or replaced according to actual requirements. Different functional components are separated or integrated or the like. For example, the acceleration unit 813 and the CPU 801 are separated, or the acceleration unit 813 is integrated on the CPU 801, and the communication part is separated from or integrated on the CPU 801 or the acceleration unit 813 or the like. These alternative implementations all fall within the scope of protection of the present disclosure.

Particularly, a process described above with reference to a flowchart according to the embodiments of the present disclosure is implemented as a computer software program. For example, the embodiments of the present disclosure include a computer program product, which includes a computer program tangibly contained in a machine-readable medium. The computer program includes a program code for executing a method illustrated in the flowchart. The program code may include corresponding instructions for correspondingly executing the operations of the methods provided by the embodiments of the present disclosure, e.g., obtaining at least one candidate region feature corresponding to at least one target in an image; obtaining at least one first probability vector corresponding to at least two classes based on the at least one candidate region feature, and classifying each class to respectively obtain at least one second probability vector corresponding to at least two sub-classes in the class; and determining a classification probability that the target belongs to the sub-class based on the first probability vector and the second probability vector. In such embodiments, the computer program is downloaded and installed from the network by means of the communication section 809, and/or is installed from the removable medium 811. The computer program, when being executed by the CPU 801, executes the foregoing functions defined in the methods of the present disclosure.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The method and apparatus in the present disclosure may be implemented in many manners. For example, the method and apparatus in the present disclosure may be implemented with software, hardware, firmware, or any combination of software, hardware, and firmware. The foregoing specific sequence of operations of the method is merely for description, and unless otherwise stated particularly, is not intended to limit the operations of the method in the present disclosure. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for executing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A method for traffic sign detection, comprising:
collecting an image comprising traffic signs;
obtaining at least one candidate region feature corresponding to at least one traffic sign in the image comprising traffic signs, each of the at least one traffic sign corresponding to one candidate region feature;
obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class; and
determining, based on the first probability vector and the second probability vector, a classification probability that the traffic sign belongs to the traffic sign sub-class.

2. The method according to claim 1, wherein the obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class comprises:
performing, by a first classifier, classification based on the at least one candidate region feature to obtain at least one first probability vector corresponding to the at least two traffic sign classes; and
performing, by at least two second classifiers, classification on each of the at least two traffic sign classes based on the at least one candidate region feature to respectively obtain at least one second probability vector corresponding to at least two traffic sign sub-classes in the traffic sign class.

3. The method according to claim 2, wherein each of the at least two traffic sign classes corresponds to one of the second classifiers;
the performing, by at least two second classifiers, classification on each of the traffic sign classes based on the at least one candidate region feature to respectively obtain at least one second probability vector corresponding to at least two traffic sign sub-classes in the traffic sign class comprises:
determining, based on the first probability vector, the traffic sign class category corresponding to the candidate region feature; and
performing, based on the second classifier corresponding to the traffic sign class, classification on the candidate region feature, to obtain a second probability vectors of the at least two traffic sign sub-classes corresponding to the candidate region feature;
wherein before the performing, based on the second classifier corresponding to the traffic sign class, classification on the candidate region feature, to obtain a second probability vectors of the at least two traffic sign sub-classes corresponding to the candidate region feature, the method further comprises:
processing, by a convolutional neural network, the candidate region feature, and inputting the processed candidate region feature into the second classifier corresponding to the traffic sign class.

4. The method according to claim 1, wherein the determining, based on the first probability vector and the second probability vector, a classification probability that the traffic sign belongs to the traffic sign sub-class comprises:
determining, based on the first probability vector, a first classification probability that the traffic sign belongs to the traffic sign class;
determining, based on the second probability vector, a second classification probability that the traffic sign belongs to the traffic sign sub-class; and
determining, by combining the first classification probability and the second classification probability, a classification probability that the traffic sign belongs to the traffic sign sub-class in the traffic sign class.

5. The method according to claim 1, wherein before the obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class, the method further comprises:
training, based on a sample candidate region feature, a traffic classification network, wherein the traffic classification network comprises one first classifier and at least two second classifiers, and a number of the at least two second classifiers is equal to a traffic sign class category of the first classifier; and the sample candidate region feature has a labeled traffic sign sub-class category, or the sample candidate region feature has a labeled traffic sign sub-class category and a labeled traffic sign class category.

6. The method according to claim 5, wherein in response to the sample candidate region feature having a labeled traffic sign sub-class category, the labeled traffic sign class category corresponding to the sample candidate region feature is determined by clustering the labeled traffic sign sub-class category.

7. The method according to claim 5, wherein the training a traffic classification network based on a sample candidate region feature comprises:
inputting the sample candidate region feature into the first classifier to obtain a predicted traffic sign class category, and adjusting a parameter of the first classifier based on the predicted traffic sign class category and the labeled traffic sign class category; and
inputting, based on the labeled traffic sign class category of the sample candidate region feature, the sample candidate region feature into the second classifier corresponding to the labeled traffic sign class category to obtain a predicted traffic sign sub-class category, and adjusting a parameter of the second classifier based on the predicted traffic sign sub-class category and the labeled traffic sign sub-class category.

8. The method according to claim 1, wherein the obtaining at least one candidate region feature corresponding to at least one traffic sign in the image comprising traffic signs comprises:
obtaining, based on the image, the at least one candidate region corresponding to the at least one traffic sign comprising traffic signs;
performing feature extraction on the image to obtain an image feature corresponding to the image; and
determining, based on the at least one candidate region and the image feature, the at least one candidate region feature corresponding to the image comprising traffic signs.

9. The method according to claim 8, wherein the determining, based on the at least one candidate region and the image feature, the at least one candidate region feature corresponding to the image comprising traffic signs comprises:
obtaining, based on the at least one candidate region, a feature of a corresponding position from the image feature to constitute the at least one candidate region feature corresponding to the at least one candidate region, each of the at least one candidate region corresponding to one candidate region feature.

10. The method according to claim 8, wherein the performing feature extraction on the image to obtain an image feature corresponding to the image comprises:
performing, by a convolutional neural network in a feature extraction network, feature extraction on the image to obtain a first feature;
performing, by a residual network in the feature extraction network, differential feature extraction on the image to obtain a differential feature; and
performing bitwise addition on the first feature and the differential feature to obtain the image feature corresponding to the image;
wherein the performing, by a convolutional neural network in a feature extraction network, feature extraction on the image to obtain a first feature comprises:
performing, by the convolutional neural network, feature extraction on the image;
processing at least one of at least two feature maps output by at least two convolutional layers so that the at least two feature maps have a same size; and
performing bitwise addition on the at least two feature maps having the same size to determine the first feature corresponding to the image.

11. The method according to claim 10, wherein before the performing, by a convolutional neural network in a feature extraction network, feature extraction on the image to obtain a first feature, the method further comprises:
performing, by a discriminator, adversarial training on the feature extraction network based on a first sample image, wherein a size of a traffic sign in the first sample image is known, the traffic sign comprises a first traffic sign and a second traffic sign, and the size of the first traffic sign is different from that of the second traffic sign.

12. The method according to claim 11, wherein the performing, by a discriminator, adversarial training on the feature extraction network based on a first sample image comprises:
inputting the first sample image into the feature extraction network to obtain a first sample image feature;
obtaining, by the discriminator, a discrimination result based on the first sample image feature, the discrimination result being used for representing the authenticity that the first sample image comprises the first traffic sign; and
alternately adjusting, based on the discrimination result and the known size of the traffic sign in the first sample image, parameters of the discriminator and the feature extraction network.

13. The method according to claim 8, wherein the performing feature extraction on the image to obtain an image feature corresponding to the image comprises:
inputting a second sample image into a convolutional neural network to obtain a prediction image feature, the second sample image comprising a labeling image feature;
adjusting, based on the prediction image feature and the labeling image feature, a parameter of the convolutional neural network;
performing, by the convolutional neural network, feature extraction on the image; and
determining, based on at least two features output by at least two convolutional layers in the convolutional neural network, the image feature corresponding to the image.

14. The method according to claim 13, wherein the determining, based on at least two feature maps output by at least two convolutional layers in the convolutional neural network, the image feature corresponding to the image comprises:
processing at least one of the at least two feature maps output by the at least two convolutional layers so that the at least two feature maps have a same size; and
performing bitwise addition on the at least two feature maps having the same size to determine the image feature corresponding to the image.

15. The method according to claim 8, wherein the obtaining, based on the image, at least one candidate region corresponding to the at least one traffic sign comprising traffic signs comprises:
obtaining at least one frame of the image comprising traffic signs from a video, and performing region detection on the image to obtain the at least one candidate region corresponding to the at least one traffic sign.

16. The method according to claim 15, wherein before the obtaining, based on the image, at least one candidate region corresponding to the at least one traffic sign comprising traffic signs, the method further comprises:
performing keypoint recognition on at least one frame of the image in the video, and determining a traffic sign keypoint corresponding to the traffic sign in the at least one frame of the image; and
tracking the traffic sign keypoint to obtain a keypoint region of the at least one frame of the image in the video;
after the obtaining, based on the image, the at least one candidate region corresponding to the at least one traffic sign, the method further comprises:
adjusting the at least one candidate region according to the keypoint region of the at least one frame of the image, to obtain at least one traffic sign candidate region corresponding to the at least one traffic sign.

17. The method according to claim 16, wherein the tracking the traffic sign keypoint to obtain a keypoint region of the at least one frame of the image in the video comprises:
based on a distance between the traffic sign keypoints in two consecutive frames of the image in the video;
realizing, based on the distance between the traffic sign keypoints, the tracking of the traffic sign keypoint in the video;
determining, based on a minimum value of the distance between the traffic sign keypoints, the position of a same traffic sign keypoint in the two consecutive frames of the image; and
realizing, according to the position of the same traffic sign keypoint in the two consecutive frames of the image, the tracking of the traffic sign keypoint in the video.

18. The method according to claim 16, wherein the adjusting, according to the keypoint region of the at least one frame of the image, the at least one candidate region, to obtain at least one traffic sign candidate region corresponding to the at least one traffic sign comprises at least one of the following:
in response to an overlapping ratio of the candidate region to the keypoint region being greater than or equal to a set ratio, using the candidate region as a traffic sign candidate region corresponding to the traffic sign; or
in response to the overlapping ratio of the candidate region to the keypoint region being less than the set ratio, using the keypoint region as the traffic sign candidate region corresponding to the traffic sign.

19. An electronic device, comprising: a memory, configured to store executable instructions; and
a processor, configured to communicate with the memory to execute the executable instructions to perform:
collecting an image comprising traffic signs;
obtaining at least one candidate region feature corresponding to at least one traffic sign in the image comprising traffic signs, each of the at least one traffic sign corresponding to one candidate region feature;
obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class; and
determining, based on the first probability vector and the second probability vector, a classification probability that the traffic sign belongs to the traffic sign sub-class.

20. A non-transitory computer storage medium, configured to store computer readable instructions, wherein when the instructions are executed, a processor is configured to perform the following operations:
collecting an image comprising traffic signs;
obtaining at least one candidate region feature corresponding to at least one traffic sign in the image comprising traffic signs, each of the at least one traffic sign corresponding to one candidate region feature;
obtaining, based on the at least one candidate region feature, at least one first probability vector corresponding to at least two traffic sign classes, and classifying each of the at least two traffic sign classes to respectively obtain at least one second probability vector corresponding to at least two traffic sign sub-classes in the traffic sign class; and
determining, based on the first probability vector and the second probability vector, a classification probability that the traffic sign belongs to the traffic sign sub-class.
